(19) United States
(12) Patent Application Publication
(10) Pub. No.: US 2018/0308348 A1
(43) Pub. Date: Oct. 25, 2018

(54) WIRELESS VOICE TRANSPARENT TRANSMISSION APPARATUS AND CONTROL TERMINAL

(71) Applicant: SENGLED CO., LTD., Shanghai (CN)

(72) Inventors: Xingming DENG, Shanghai (CN); Jinxiang SHEN, Shanghai (CN)

(21) Appl. No.: 16/017,549

(22) Filed: Jun. 25, 2018

Related U.S. Application Data
(63) Continuation-in-part of application No. PCT/CN2016/110334, filed on Dec. 16, 2016.

(30) Foreign Application Priority Data
Dec. 30, 2015 (CN) 201511021927.4

(51) Int. Cl. G08C 17/02; H04W 76/14; G10L 15/22; G10L 15/08

(52) U.S. Cl. CPC G08C 17/02; H04W 76/14; G10L 15/22; H04W 84/12; G10L 2015/223; G10L 2015/088; G10L 15/08

(57) ABSTRACT

In accordance with various embodiments of the disclosed subject matter, a wireless voice transparent transmission apparatus and a related control terminal are provided. The wireless voice transparent transmission apparatus includes an input unit configured for collecting a voice command; a control unit connected to the input unit configured for acquiring an audio signal corresponding to the voice command collected by the input unit in real time; and a wireless transmission unit including a software access application programming interface (API) and a radio frequency (RF) module. The RF module is connected to the control unit, the software access API is configured for establishing a wireless network connection between the RF module and at least one wireless terminal, the RF module is configured for transmitting the audio signal acquired by the control unit to the at least one wireless terminal.

### CROSS-REFERENCES TO RELATED APPLICATIONS

This application is a continuation-in-part application of International Application No. PCT/CN2016/110334, filed on Dec. 16, 2016, claims priority of Chinese Patent Application No. 201511021927.4, filed on Dec. 30, 2015, the entire content of which is incorporated by reference herein.

### TECHNICAL FIELD

The disclosed subject matter generally relates to the field of smart control technology and, more particularly, relates to a wireless voice transparent transmission apparatus and a related control terminal.

### BACKGROUND

With the continuous development of smart home technology, voice control is widely used in daily life. For example, a user can remotely control various household electrical appliances by using the voice control technology. However, the existing voice control of a specific household electrical appliance is limited to a short distance, generally no more than 5 meters. In order to make an effective voice control, the user must be approaching to the household electrical appliance, and making a voice command towards a direction of a voice recognition coverage area of the household electrical appliance. However, if the distance between the user and the household electrical appliance is beyond a maximum voice recognition coverage distance, or if the voice command is not aligned with the voice recognition coverage area, the voice control may be invalidated and the user experience may be seriously affected.

Accordingly, it is desire to provide a wireless voice transparent transmission apparatus and a related control terminal.

### BRIEF SUMMARY

In accordance with some embodiments of the disclosed subject matter, a wireless voice transparent transmission apparatus and a related control terminal are provided.

An aspect of the present disclosure provides a wireless voice transparent transmission apparatus. The wireless voice transparent transmission apparatus may include an input unit configured for collecting a voice command; a control unit connected to the input unit configured for acquiring an audio signal corresponding to the voice command collected by the input unit in real time; and a wireless transmission unit including a software access application programming interface (API) and a radio frequency (RF) module. The RF module is connected to the control unit, the software access API is configured for establishing a wireless network connection between the RF module and at least one wireless terminal, the RF module is configured for transmitting the audio signal acquired by the control unit to the at least one wireless terminal.

Optionally, the control unit may be further configured for: detecting a voice input in real time; and in response to detecting the voice input, triggering and performing an audio signal acquisition process until detecting an end of the voice input.

Optionally, the control unit may include an Analog to Digital (A/D) module for converting an analog voice signal to a digital audio signal.

Optionally, the RF module may include at least one of a Wi-Fi module, a Bluetooth module, a ZigBee module, and a Wireless 433 module.

Optionally, the input unit includes at least one microphone.

Optionally, the at least one microphone is an omni-directional microphone.

Optionally, the at least one microphone is a directional microphone.

Optionally, the RF module may include: a modulation circuit configured for modulating the audio signal acquired by the control unit in accordance with a preset modulation scheme to obtain a modulated signal; and a transmitter connected to the modulation circuit configured for transmitting the modulated signal in a wireless manner.

Another aspect of the present disclosure provides a control terminal, including the disclosed wireless voice transparent transmission apparatus.

Optionally, the control terminal is at least one of a smart phone, a personal digital assistant, a personal computer, a home gateway, a wireless modem, a set top box, a data card, and a wireless router.

Another aspect of the present disclosure provides a method for wireless voice transparent transmission. The method may include collecting, by an input unit, a voice command; acquiring, by a control unit, an audio signal corresponding to the voice command collected by the input unit in real time; establishing, by a software access application programming interface (API), a wireless network connection between a radio frequency (RF) module and at least one wireless terminal; and transmitting the audio signal acquired by the control unit from the RF module to the at least one wireless terminal.

Optionally, acquiring the audio signal may further include: detecting a voice input in real time; and in response to detecting the voice input, triggering and performing an audio signal acquisition process until detecting an end of the voice input to obtain the audio signal.

Optionally, the method may further include: converting, by an Analog to Digital (A/D) module, the audio signal from an analog type into a digital type.

Optionally, transmitting the audio signal may further include: transmitting the audio signal from the RF module to the at least one wireless terminal by using one of a Wireless Fidelity (Wi-Fi) technology, a Bluetooth technology, a ZigBee protocol (ZigBee) technology, and a Wireless 433 technology.

Optionally, the input unit includes at least one microphone.

Optionally, the at least one microphone is an omni-directional microphone.

Optionally, the at least one microphone is a directional microphone.

Optionally, transmitting the audio signal may further include: modulating, by a modulation circuit, the audio signal acquired by the control unit in accordance with a preset modulation scheme to obtain a modulated signal; and transmitting, by a transmitter, the modulated signal in a wireless manner.

Optionally, the method is implemented by a wireless voice transparent transmission apparatus integrated in a control terminal.

Optionally, the control terminal is at least one of a smart phone, a personal digital assistant, a personal computer, a home gateway, a wireless modem, a set top box, a data card, and a wireless router.

Other aspects of the present disclosure can be understood by those skilled in the art in light of the description, the claims, and the drawings of the present disclosure.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements. It should be noted that the following drawings are merely examples for illustrative purposes according to various disclosed embodiments and are not intended to limit the scope of the present disclosure.

FIG. 1 is a schematic structural diagram of an exemplary wireless voice transparent transmission apparatus in accordance with some embodiments of the present disclosure;

FIG. 2 is a schematic structural diagram of another exemplary wireless voice transparent transmission apparatus in accordance with some other embodiments of the present disclosure;

FIG. 3 is a schematic structure of an exemplary lighting device integrating the wireless voice transparent transmission apparatus in accordance with the disclosed embodiments;

FIG. 4 is a flow chart illustrating an exemplary wireless voice transparent transmission process in accordance with the disclosed embodiments; and

FIG. 5 is a schematic diagram of an exemplary wireless voice transmission system in accordance with the disclosed embodiments.

### DETAILED DESCRIPTION

For those skilled in the art to better understand the technical solution of the disclosed subject matter, reference will now be made in detail to exemplary embodiments of the disclosed subject matter, which are illustrated in the accompanying drawings. Wherever possible, the same reference numbers will be used throughout the drawings to refer to the same or like parts.

In accordance with various embodiments, the disclosed subject matter provides a wireless voice transparent transmission apparatus and a related control terminal.

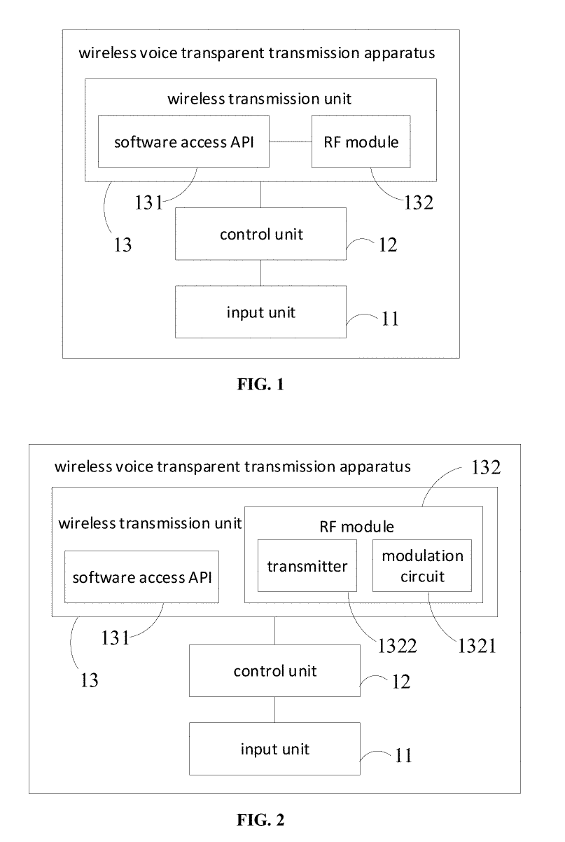

Referring to FIG. 1, a schematic structural diagram of an exemplary wireless voice transparent transmission apparatus is shown in accordance with some embodiments of the disclosed subject matter. The voice transparent transmission apparatus, as used herein, may refer to a voice transmission apparatus, a voice transponder, or a voice signal pass-through transmission apparatus. As illustrated, the wireless voice transparent transmission apparatus can include an input unit 11, a control unit 12, and a wireless transmission unit 13.

The input unit 11 is configured for collecting a voice command.

The voice command can be a voice instruction that a user wishes to wirelessly transmit to a controlled smart terminal through the disclosed wireless voice transparent transmission apparatus. For example, a user may send a voice instruction “Play House of Cards Season 3 Episode 10” to a smart TV through the wireless voice transparent transmission apparatus.

The control unit 12 is connected to the input unit 11 for acquiring an audio signal corresponding to the voice command collected by the input unit 11 in real time.

The wireless transmission unit 13 can include a software access application programming interface (API) 131 and a radio frequency (RF) module 132. The RF module 132 is connected to the control unit 12. The software access API 131 is configured for establishing a wireless network connection between the RF module 132 and at least one wireless terminal. The RF module 132 is configured for transmitting the audio signal acquired by the control unit 12 to the at least one wireless terminal. Further, the wireless terminal may perform voice recognition process on the audio signal and respond to the voice command accordingly. With the previous example, when the smart TV receives the audio signal containing the command “Play House of Cards Season 3 Episode 10” sent by the wireless transmission unit 13, the smart TV may search for the specific episode and play the episode.

In some embodiments, the input unit 11 can include one or more microphones. The settings of the one or more microphones can be determined according to the particular application.

In one embodiment, in order to achieve a better voice recognition effect, the input unit 11 can include an omni-directional microphone for collecting the voice command.

In another embodiment, the input unit 11 can use one or more directional microphones for collecting the voice command. Comparing to the omni-directional microphone, the one or more directional microphones may reduce the hardware cost, while also substantially meeting the application requirements of the wireless voice transparent transmission apparatus.

In a practical application, the control unit 12 may be further configured to detect a trigger of a voice input (e.g., when a voice input begins) in real time. In response to detecting a voice input, an audio signal acquisition process may be triggered and performed on the inputted voice data until the control unit 12 detects an end of the voice input. Exemplarily, the control unit 12 can use a software algorithm to determine whether there is a voice data input triggered, and can use another software algorithm to determine an end of the voice data input. In one example, the control unit 12 may determine whether a voice input is a human voice input (e.g., based on frequency, volume and other characteristics of the audio signal collected by the input unit 11), and trigger the audio signal acquisition process when a human voice input is detected. In another example, the control unit 12 may apply certain filters to the voice input to eliminate background noise and identify desired voice input.

In a practical application, the RF module 132 may be further configured for transmitting audio signals by using any suitable technology, such as Wireless Fidelity (Wi-Fi) technology, Bluetooth technology, ZigBee protocol (ZigBee) technology, and Wireless 433 technology, etc. In one embodiment, the RF module 132 may further include any one of a Wi-Fi module, a Bluetooth module, a ZigBee module, and a Wireless 433 module.

By using a software access API provided by a wireless transmission unit, the disclosed wireless voice transparent transmission apparatus can realize a wireless communication interconnection between the controlled wireless terminals and the wireless voice transparent transmission apparatus, so that a voice recognized distance (i.e., effective voice recognition distance) can be more than 50 meters, or even farther. Even if a user is far from a controlled wireless terminal, the voice control instruction can be effectively transmitted through the wireless voice transparent transmission apparatus to realize an effective control of the controlled wireless terminal, and the user experience can be improved.

In some embodiments, the wireless voice transparent transmission apparatus (e.g., the software access API) may provide an interface for initial setup to establish the connection to the controlled wireless terminal, such as a graphical user interface, or a connection button and a connection-status indication light. During the initial setup, the wireless voice transparent transmission apparatus may search and identify a to-be-paired smart appliance (e.g., on the internet, in a local area network, in a Bluetooth coverage range, etc.). The to-be-paired smart appliance may also enter a pairing mode for establishing the connection (e.g., through a pairing digit code, a QR code, or an automatic pairing communication protocol). After the initial setup is complete, the controlled terminal may receive voice command from the wireless voice transparent transmission apparatus.

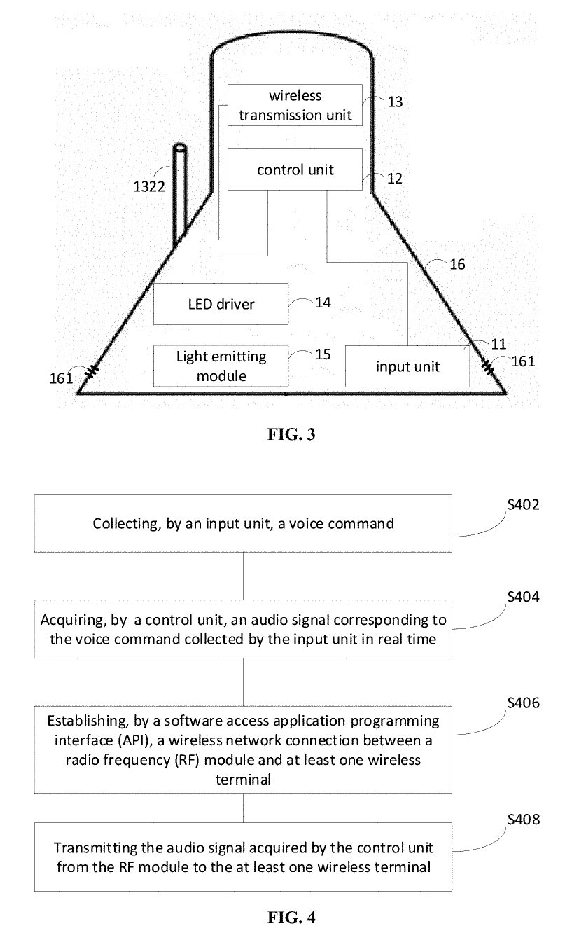

Referring to FIG. 2, a schematic structural diagram of another exemplary wireless voice transparent transmission apparatus is shown in accordance with some other embodiments of the disclosed subject matter.

As illustrated, based on the structure of the wireless voice transparent transmission apparatus described above in connection with FIG. 1, the control unit 12 can include an Analog to Digital (A/D) module or an Analog to Digital Converter (ADC) for converting an analog voice signal into a digital audio signal.

It should be noted that, the voice command collected by the input unit 11 is an analog voice signal which can be converted into a digital audio signal by the control unit 12 to facilitate radio/wireless transmission.

In addition, the RF module 132 in the wireless transmission unit 13 of the wireless voice transparent transmission apparatus may further include a modulation circuit 1321 and a transmitter 1322. The modulation circuit 1321 may be used to modulate the audio signal acquired by the control unit in accordance with a preset modulation scheme to obtain a modulated signal. The transmitter 1322 is connected to the modulation circuit 1321 for transmitting the modulated signal in a wireless manner.

In order to ensure the transmission effect, and to overcome the problems of long-distance signal transmission, the signal spectrum can be converted to a high-frequency channel for transmission. The modulation circuit 1321 may perform a modulation process to load the audio signal to a high-frequency carrier signal for transmission. In practical applications, any suitable modulation process, including amplitude modulation, frequency modulation and phase modulation, can be used to modulate the analog audio signal or digital signals.

In some embodiments, the at least one wireless terminal includes a central controller of a voice transmission system, and the wireless transmission unit is further configured to receive a control command from the central controller and inform the control unit to execute the control command (e.g., adjusting a light brightness). The software access API is compatible with the central controller and is invoked to transmit the audio signal to central controller and to read the control command from the central controller.

Another aspect the present disclosure provides a control terminal in which a disclosed wireless voice transparent transmission apparatus described above in connection with FIGS. 1 and 2 can be integrated. The control terminal can be used for remote voice control of a designated device.

In some embodiments, the control terminal may be a smart phone, a personal digital assistant, a personal computer, a home gateway, a wireless modem, a set top box, a data card, a wireless router, or any other suitable household electrical appliance.

In some embodiments, multiple smart household electrical appliances can be remotely controlled via voice command by using a single control terminal. For example, a smart phone can be used to transmit the voice signal to a smart refrigerator, a smart lighting, a smart television, etc.

In one embodiment, when receiving a voice command, the control unit 12 may be further configured to preprocess the voice command, identify one or more of the electrical appliances that correspond to the voice command, and control the wireless transmission unit 13 to send the voice command to the identified electrical appliance(s). Specifically, the control unit 13 may be configured to store a list of connected appliances and one or more keywords corresponding to each connected appliance. In one example, when the voice command is “Play House of Cards Season 3 Episode 10,” the control unit 12 may recognize the keyword “play” and send the voice command to the TV. In another example, when the voice command is “Play House of Cards Season 3 Episode 10 on living room TV,” the control unit 12 may recognize the keyword “living room TV” and send the voice command to the TV in the living room. In another example, when the voice command is “turn on the lights,” the control unit 12 may recognize the keyword “lights” and send the voice command to all connected smart lights.

In another embodiment, when receiving a voice command, the control unit 12 may control the wireless transmission unit 13 to send the voice command to all of the electrical appliances, such that one or more electrical appliances capable of recognizing the voice command may respond to the voice command. For example, a smart light may not respond to a received voice command “Play House of Cards Season 3 Episode 10,” while a smart TV may respond to the received voice command.

In some embodiments, one smart household electrical appliance can be remotely controlled via voice command by using multiple control terminals. For example, a smart television can be remotely controlled via voice command by using a smart phone, and a personal computer, etc.

FIG. 3 is a schematic structure of an exemplary lighting device integrating the wireless voice transparent transmission apparatus in accordance with the disclosed embodiments. As shown in FIG. 3, the lighting device may include a control unit 12, a wireless transmission unit 13, an LED driver 14, and a light emitting module 15. The lighting device may further include a lamp cover 16.

Specifically, the control unit 12, and the wireless transmission unit 13 may function in a similar manner as disclosed in FIG. 1 and FIG. 2. The LED driver 14 may be configured to provide power supply to the light emitting module 15, including converting external power source to a voltage/current satisfying working conditions of the light emitting module 15. The LED driver 14 may be further configured to adjust lighting status of the light emitting module 15 (e.g., brightness, color, temperature). The light emitting module 15 may be configured to emit light accordingly. In some embodiments, the control unit 12, the wireless transmission unit 13, and the LED driver 14 may be integrated in one circuit board, which is installed in the lighting device. The antenna portion 1322 of the RF module 132 may be positioned inside or outside the lamp cover 16. The LED driver 14 may be further configured to provide power supply to other components of the lighting device, including the input unit 11, the control unit 12, and the wireless transmission unit 13.

In some embodiments, the lighting device may further include an input unit 11. A designated area on the lamp cover 16 may be perforated to accommodate the input unit 11. For example, four sets of microphone holes 161 may be configured at a same horizontal level on the lamp cover 16 at 0, 90, 180, and 270 degrees. The input unit 11 may include microphones positioned on the inner side of the lamp cover 16 at corresponding locations of the microphone holes. As the lighting devices may be placed at various locations in a household or a work place, users may speak a voice command towards any lighting device to control a smart appliance paired with the lighting device. The lighting device may send the voice command for the smart appliance to respond to the voice command.

It can be understood that other electrical appliance can implement/incorporate the wireless voice transparent transmission apparatus in a similar manner as the disclosed lighting device, such as a wireless speaker, a smart TV, etc. That is, a user does not need to configure a specific voice transmission system by setting up particular devices that only have voice transparent communication functionalities at different physical locations. The wireless voice transparent transmission apparatus can be embedded in an electrical appliance that has its own intended use and share the same power supply of the electrical appliance.

In some embodiments, the control unit 12, and the wireless transmission unit 13 of the disclosed wireless voice transparent transmission apparatus may be implemented on a first control terminal (e.g., the lighting device), and the input unit 11 of the disclosed wireless voice transparent transmission apparatus may be implemented on a second control terminal (e.g., a smartphone). Specifically, the transmission unit 13 in the first control terminal may support at least two communication protocols, including a first communication protocol for transmission to the controlled electrical appliance(s), and a second communication protocol for transmission to the second control terminal.

For example, a user may use a smart phone (second control terminal) to communicate with a lighting device (first control terminal) via Internet connection, and the lighting device may communicate with a smart refrigerator (controlled terminal) via infrared connection. The user may speak a voice command to input unit 11 in the smart phone, the smart phone may transmit the voice command to the wireless transmission unit 13 in the lighting device, and the wireless transmission unit 13 in the lighting device may further transmit the voice command to the smart refrigerator. In this way, users can use voice command to remotely control smart appliances through the disclosed wireless voice transparent transmission apparatus.

In some embodiments, the lighting device may also function as a controlled terminal. For example, the input unit 11 (e.g., on a smart phone or on the lighting device) may receive a lighting control voice command. The lighting control voice command may be a query command for obtaining current status of the light, such as on/off status, color, and brightness level, or an adjust command for changing the current status of the light. The control unit 12 may be further configured to process the lighting control voice command (e.g., received by the wireless communication unit 13 from the input unit 11 in the smart phone, or directly received by the input unit 11 in the lighting device) and respond to the processed command accordingly. In one example, the control unit 12 may instruct the LED driver to adjust the emitted light of the light emitting module 15 based on the voice command. In another example, the control unit 12 may obtain information from the LED driver about the current lighting status and send to the smartphone through the wireless communication unit 13. Accordingly, on the smartphone, a user interface may be configured to display the lighting status and allow users to adjust the lighting status, or a speaker may be configured to read the lighting status or confirm the completion of the lighting status adjustment.

FIG. 4 is a flow chart illustrating an exemplary wireless voice transparent transmission process in accordance with the disclosed embodiments. The process may be implemented by, for example, the wireless voice transparent transmission apparatus as disclosed in FIG. 1 or FIG. 2, the disclosed control terminal, and the lighting device as disclosed in FIG. 3.

As shown in FIG. 4, the method for wireless voice transparent transmission may include: collecting, by an input unit, a voice command (S402). The input unit may include at least one microphone. The at least one microphone may include an omni-directional microphone or a directional microphone. Further, a control unit may acquire an audio signal corresponding to the voice command collected by the input unit in real time (S404). In some embodiments, the control unit may detect a voice input (e.g., from the input unit) in real time; and in response to detecting the voice input, the control unit may trigger and perform an audio signal acquisition process (e.g., through the input unit) until detecting an end of the voice input to obtain the audio signal. In some embodiments, an Analog to Digital (A/D) module may be used to convert the audio signal from an analog type into a digital type.

Further, a software access application programming interface (API) may establish a wireless network connection between a radio frequency (RF) module and at least one wireless terminal (S406). The RF module may transmit the audio signal acquired by the control unit from the RF module to the at least one wireless terminal (S408). In some embodiments, the audio signal may be transmitted from the RF module to the at least one wireless terminal by using one of a Wireless Fidelity (Wi-Fi) technology, a Bluetooth technology, a ZigBee protocol (ZigBee) technology, and a Wireless 433 technology.

In some embodiments, a modulation circuit may modulate the audio signal acquired by the control unit in accordance with a preset modulation scheme to obtain a modulated signal, and a transmitter (e.g., RF module) may send the modulated signal in a wireless manner. In some embodiments, the control unit may implement the modulation scheme to the audio signal.

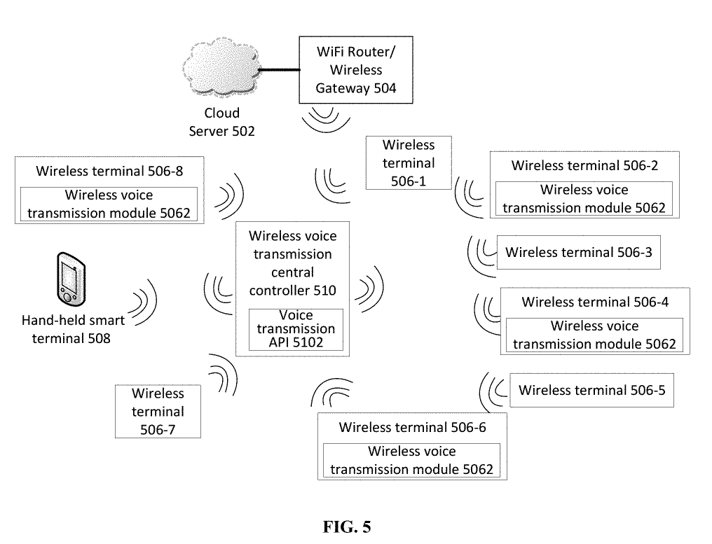

The present disclosure further provides a wireless voice communication system. FIG. 5 is a schematic diagram of an exemplary wireless voice communication system 500 in accordance with the disclosed embodiments. As shown in FIG. 5, the system 500 may include a router 504, a wireless voice transmission central controller 510 (hereinafter abbreviated as central controller) and one or more wireless terminal 506. In some embodiments, the system 500 may further include a cloud server 502, and/or a hand-held smart terminal 508.

The wireless router 504 is configured to provide an intranet wireless network for the wireless terminals 506 and the central controller 510. That is, when connecting to the wireless network provided by the router 504, the wireless terminals 506 and the central controller 510 can perform data communication between each other and transmit/receive audio signals and/or control signals. In some embodiments, the router 504, the wireless terminals 506 and the central controller 510 form a star network. Any proper wireless communication protocol may be implemented by the router 504, the wireless terminals 506 and the central controller 510, such as Wi-Fi, Bluetooth, ZigBee, Wireless 433, etc.

The wireless terminal 506 is configured to establish a connection with the central controller 510 (e.g., via the router 504), receive a control signal from the central controller 510, and adjust its operation status based on the control signal. In some embodiments, the control signal may be an audio signal containing a voice command. The wireless terminal 506 may be further configured to analyze the audio signal to obtain the voice command; and adjust its operation status based on the voice command.

The wireless terminal 506 may include two types: a first-type wireless terminal which is embedded with a wireless voice transmission module 5062, and a second-type wireless terminal that is not embedded with a wireless voice transmission module. The first-type wireless terminal may be implemented by the wireless voice transparent transmission apparatus as shown in FIG. 1 or FIG. 2. The wireless voice transmission module 5062 may be implemented by the wireless transmission unit 13 as shown in FIG. 1 or FIG. 2. The first-type wireless terminal is configured to collect an audio signal; and transmit the audio signal to other wireless terminal(s) (e.g., via the central controller 510). The voice transmission between the wireless terminal 506 and the central controller 510 may be facilitated by the voice transmission API 5102 of the central controller 510 and the software access API 131 of the wireless terminal. The second-type wireless terminals may be an electrical appliance that can be controlled based on a control signal generated according to a voice command collected by a first-type wireless terminal. In some embodiments, the first-type wireless terminal is further configured to forward an audio signal collected by another first-type wireless terminal to the central controller 510; and/or forward a control signal received from the central controller 510 to other wireless terminal(s).

For example, as shown in FIG. 5, terminals 506-2, 506-4, 506-6, and 506-8 are the first-type wireless terminals, and terminals 506-1, 506-3, 506-5, and 506-7 are second-type wireless terminals. In an exemplary embodiment, the system 500 includes at least two wireless terminals 506, and at least one of the two wireless terminals is the first-type wireless terminal (i.e., a wireless terminal having voice transmission capabilities.

The central controller 510 is configured to receive an audio signal collected by a first wireless terminal having a wireless voice communication module; generate a control signal according to the audio signal; and send the control signal to a second wireless terminal, such that the second wireless terminal responds to the control signal correspondingly. In one embodiment, the central controller 510 may be configured to directly send the audio signal as the control signal to the second wireless terminal. In another embodiment, the central controller 510 may be configured to demodulate the audio signal. In another embodiment, the central controller 510 may be configured to analyze the audio signal, determine that the audio signal contains a voice command directed to a second wireless terminal, generate the control signal directed to the second wireless terminal according to the voice command. In some embodiments, the central controller 510 may be any existing voice control device installed with the disclosed the voice transmission API 5102. The voice transmission API 5102 is specifically developed to control and perform transparent voice communication compatible with the software access API 131 installed in the first-type wireless terminals 506. That is, as long as a voice control device (e.g., devices available on market by any manufacturer, previously-used device in other occasions) allows to be installed with the disclosed the voice transmission API 5102, the voice control device can be used as the central controller 510 in the disclosed system.

Further, in existing technologies, multiple voice controllers are required to be installed to achieve transparent voice communication and voice control at multiple locations (i.e., installing one voice controller at each of the desired locations), which is not cost-effective, and each voice controller only implements a single function. Compared to the existing technologies, the disclosed system 500 only needs to include a single central controller 510 dedicated for voice control, which saves extra cost and efforts in purchasing and installing multiple voice controllers. The disclosed system 500 further utilizes electronical appliances as transparent voice communication apparatus, which achieves dual-functions including both voice transmission and originally-intended purpose. Since the electronical appliances are already supposed to be installed at multiple locations, the need to install separate voice controllers are eliminated. In addition, the wireless voice transmission modules 5062 embedded in the first-type wireless terminals 506 may be implemented with low-cost hardware compared to a traditional voice controller because they are only used for transparent communication without fulfilling the capability to implement functions related to analyzing the voice command, which is achieved by the central controller 510. With such configuration, the disclosed system 500 can realize same functions as a traditional voice controlling system with lower costs and improved efficiency.

In some embodiments, the first-type wireless terminals are generally placed/installed at fixed locations. For example, the wireless terminals having the wireless voice communication module may be the lighting devices shown in FIG. 3 or other household electrical appliances. The lighting devices can be placed in different locations (e.g., rooms) in a house. The disclosed system allows a user to speak a voice command to any lighting device (e.g., a first lighting device) for controlling a smart appliance (e.g., when the user is not in a voice recognition coverage area of the smart appliance), the first lighting device can collect an audio signal containing the voice command using its embedded microphone(s) and send out the audio signal, and the smart appliance can respond to the voice command. In one example, the first lighting device can perform transparent voice transmission and the smart appliance can be one of the lighting devices or other device having wireless connection capabilities such that the voice command can be received wirelessly. In another example, the smart appliance does not necessarily have wireless connection capabilities. The voice command can be played by a speaker embedded in a second lighting device located within the voice recognition coverage area of the smart appliance and received the voice command wirelessly from the first lighting device. In another example, the smart appliance does not necessarily have voice recognition capabilities. The central controller is configured to recognize the voice command, generate a control signal compatible and recognizable for the smart appliance, and send the control signal to the smart appliance.

In some embodiments, the central controller 510 is further configured to operate at a monopoly mode (e.g., implemented by calling the voice transmission API 5102). At the monopoly mode, only one audio signal transmitted to the central controller 510 is processed at one time. In other words, if multiple audio signals are transmitted during a same time period, the central controller 510 is configured to process only one of the signals. That is, the central controller 510 is configured to, when receiving a first audio signal, assign a monopoly processing right to the first audio signal; process the first audio signal (e.g., by analyzing the first audio signal and/or sending out a first control signal according to the first audio signal); and release the monopoly processing right after the first audio signal is processed (e.g., after sending the first control signal or after receiving a confirmation from a corresponding wireless terminal that a voice command contained in the first audio signal is responded). If a second audio signal is collected and sent to the central controller 510 and the monopoly processing right is not released, the central controller 510 is configured to wait until the monopoly processing right is released to process the second audio signal; or ignore/discard the second audio signal (e.g., prohibit the second audio signal from passing-through the central controller).

In some embodiments, the audio signals sent to the central controller 510 may be accompanied with a time stamp of signal collection time and/or a priority information (e.g., a priority level of the wireless terminal that collects the audio signal or a priority level indicated in the voice command). When the central controller 510 receives two or more audio signals at a same time, the central controller 510 is configured to identify an audio signal associated with an earliest (or latest) signal collection time and/or a highest priority level; and assign the identified audio signal with the monopoly processing right.

In some embodiments, the central controller 510 is further configured to operate at a parallel mode (e.g., implemented by calling the voice transmission API 5102). At the parallel mode, multiple audio signals are transmitted to and processed by the central controller 510 at a same time. Specifically, in one embodiment, the central controller 510 is configured to analyze a first audio signal to obtain a first voice command contained in the first audio signal; determine a wireless terminal designated by the first voice command; and determine whether there is a previous voice command designated to the same wireless terminal. The previous voice command may be a voice command processed by the central controller and directed to the same wireless terminal within a preset time duration (e.g., within 20 seconds). If there are multiple previous voice commands, the most recent voice command is used as the previous voice command. The central controller 510 is configured to: if no previous voice command directed to the same wireless terminal is found, send a first control signal corresponding to the first voice command to the wireless terminal such that the control operation can be executed by the wireless terminal; and if a previous voice command is found, determine a control operation type indicated by the first voice command; and determine whether a previous voice command and the first voice command indicate a same type of control operation. For example, control operations of turning the light on/off or changing a brightness level can be viewed as the same type of control operation, changing a brightness level and adjusting a color temperature are different types of control operations, adjusting a volume of a TV and changing a video content played by the TV are different types of control operation, requesting the TV to play a first content and requesting the TV to play a second content are same type of control operations. If the previous voice command and the first voice command indicates different types of control operations, the central controller 510 is configured to send a first control signal corresponding to the first voice command to the wireless terminal such that the control operation can be executed by the wireless terminal.

If the previous voice command and the first voice command indicate a same type of control operation, the central controller 510 is further configured to determine whether the wireless terminal is currently responding to a previous voice command. For example, the central controller 510 may determine the wireless terminal is currently responding to the previous voice command if a control signal associated with the previous voice command is not yet sent to the wireless terminal; or if a confirmation message of operation completion is not received from the wireless terminal after the control signal associated with the previous voice command is sent out, or if the control signal associated with the previous voice command is sent out within a predetermined time period (e.g., less than 5 seconds ago). The central controller 510 is configured to, when determining that the wireless terminal is not currently responding to the previous voice command, send the first control signal corresponding to the first voice command to the wireless terminal such that the control operation can be executed by the wireless terminal. In one embodiment, when determining that the wireless terminal is currently responding to the previous voice command, the central controller 510 may be configured to ignore the first voice command without generating or sending first control signal to the wireless terminal. In another embodiment, when determining that the wireless terminal is currently responding to the previous voice command, the central controller 510 may be configured to stop sending the control signal associated with the previous voice command; or inform the wireless terminal to stop processing the previous voice command. Further, the central controller 510 may send the first control signal corresponding to the first voice command to the wireless terminal such that the control operation can be executed by the wireless terminal.

In some embodiments, at the parallel mode, the central controller 510 is configured to maintain a queue of to-be-processed audio signals received from the wireless terminals 506 and count a number of the to-be-processed audio signals in the queue. The central controller 510 is further configured to: compare the number with a preset threshold (denoted as N, N being an integer greater than 1); if the number is less than the preset threshold, process the audio signals in the queue sequentially; and if the number is not less than the preset threshold, stop comparing the number with the preset threshold, process the first N audio signals in the queue as a batch, and start comparing the number with the preset threshold when the batch are completely processed. In one embodiment, when processing the first N audio signals as a batch, the central controller 510 is configured to identify wireless terminals designated by the N audio signals; determine whether there are two or more audio signals directed to the same wireless terminal; if no audio signals are directed to the same wireless terminal, generate and send out control signals correspondingly; if two or more audio signals are directed to the same wireless terminal, determine whether the two or more audio signals indicate a same type of control operation; if the two or more audio signals indicate different types of control operations, generate and send out control signals correspondingly; and if the two or more audio signals indicate same types of control operations, select one audio signal from the two or more audio signals to process and generate the control signal, and discard the remaining audio signals. The selected audio signal may be an audio signal with earliest/latest collection time, or an audio signal sent from a terminal having highest priority.

In some embodiments, the system 500 may further include a smart terminal 508. The smart terminal 508 may be a hand-held terminal that can be easily carried around by a user, such as a remote controller, a mobile phone, a tablet, etc. The smart terminal 508 is configured to establish a wireless connection with the central controller 510 and send operation instruction to the central controller 510. The operation instruction may be a desired configuration setting of an operation mode of the central controller 510 (e.g., a user selection made between the monopoly mode and the parallel mode), or an instruction to adjust operation status of any wireless terminal in the system 500 (e.g., turning off dining room light, playing classical music in bedroom, etc.). The operation instruction may be in the form of a voice command recorded by the smart terminal 508 or a user input entered on graphical user interface provided by an application program associated with the system 500. The central controller 510 is configured to receive the operation instruction and respond to the operation instruction accordingly. In some embodiments, the application program installed on the smart terminal 508 is configured to identify all wireless terminals in the network that has the capability to function as a central controller; and allow the user to select one of the identified wireless terminals as the central controller 510. In some embodiments, the application program is configured to display wireless terminals on the graphical user interface; and allow the user to label the wireless terminals with desired names, such as labeling a first wireless terminal as “bedroom light” and a second wireless terminal as “dining room light.” In this way, the central controller 510 is configured to store corresponding relationships between the labels and the wireless terminals 506; and identify a voice command is directed to a specific wireless terminal when the recognized voice command contains the corresponding label. In some embodiments, the smart terminal 508 may integrate the software access API 131 and function as a first-type wireless terminal 506 itself. That is, the smart terminal 508 may perform transparent voice transmission to the central controller 510 such that the central controller 510 processes the transmitted voice data accordingly.

In some embodiments, the wireless router 504 is further configured to establish a wireless connection with the smart terminal 508. That is, the smart terminal 508 can access/control the central controller 510 and the wireless terminals 506 in the network by connecting to the wireless router 504. In some embodiments, the wireless router 504 is further configured to connect to the Internet. That is, the smart terminal 508 can access the intranet network remotely by connecting to the wireless router 504 on the Internet. In some embodiments, the wireless router 504 may be incorporated and embedded within the central controller 510 as one device.

In some embodiments, the system 500 may further include a cloud server 502. The cloud server 502 is configured to store configuration information of the wireless terminals 506 and the central controller 510; provide hardware and/or software updates to the wireless terminals 506, the smart terminal 508 and the central controller 510; and respond to an operation instruction from the smart terminal 508 (e.g. by receiving the operation instruction from the remotely connected smart terminal 508, sending the operation instruction to the central controller 510 through the wireless router such that the operation instruction can be processed and handled correspondingly). The configuration information of a wireless terminal may include: type and model number of the wireless terminal, types of control operations available for the wireless terminal, corresponding relationships between triggering keywords and control operations, compatible format of a control signal for the wireless terminal, customized settings preset by the user, etc. In some embodiments, when a wireless terminal is newly connected to the system 500, the cloud server 502 is configured to query the stored configuration information based on a model number of the newly connected wireless terminal; and send the corresponding information to the central controller 510 such that the central controller 510 can determine whether a voice command is directed to the newly added wireless terminal based on the corresponding configuration information.

By implementing the disclosed system and apparatus, smart home control is realized by arranging/distributing wireless terminals with voice transparent transmission capabilities at various locations. In this way, any smart appliance in the network can be controlled by a voice command at any location regardless of whether the user is in audio signal collection area of the smart appliance, as long as there is a wireless terminal having voice transparent transmission capabilities at the location. The wireless terminals with voice transparent transmission capabilities themselves are also functional smart appliances, such that no extra voice transmission devices are required to implement smart home control.

It should be understood by those of ordinary skill in the art that, all or part of the steps of implementing the above-described embodiments may be accomplished by program related hardware. The program may be stored in a computer-readable storage medium. When the program is executed, the steps including the above-described embodiments can be executed. The storage medium can include various kinds of media, such as a ROM, a RAM, a magnetic disk, or an optical disk, on which program codes can be stored.

The descriptions of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Although the disclosed subject matter has been described and illustrated in the foregoing illustrative embodiments, it is understood that the present disclosure has been made only by way of example, and that numerous changes in the details of embodiment of the disclosed subject matter can be made without departing from the spirit and scope of the disclosed subject matter, which is only limited by the claims which follow. Features of the disclosed embodiments can be combined and rearranged in various ways. Without departing from the spirit and scope of the disclosed subject matter, modifications, equivalents, or improvements to the disclosed subject matter are understandable to those skilled in the art and are intended to be encompassed within the scope of the present disclosure.

What is claimed is:

1. A wireless voice transparent transmission apparatus, comprising:
an input unit configured for collecting a voice command;
a control unit connected to the input unit configured for acquiring an audio signal corresponding to the voice command collected by the input unit in real time;
a wireless transmission unit including a software access application programming interface (API) and a radio frequency (RF) module, wherein the RF module is connected to the control unit, the software access API is configured for establishing a wireless network connection between the RF module and at least one wireless terminal, the RF module is configured for transmitting the audio signal acquired by the control unit to the at least one wireless terminal.

2. The wireless voice transparent transmission apparatus of claim 1, wherein the control unit is further configured for:
detecting a voice input in real time; and
in response to detecting the voice input, triggering and performing an audio signal acquisition process until detecting an end of the voice input.

3. The wireless voice transparent transmission apparatus of claim 1, wherein the at least one wireless terminal includes a central controller of a voice transmission system, and the wireless transmission unit is further configured to receive a control command from the central controller and inform the control unit to execute the control command.

4. The wireless voice transparent transmission apparatus of claim 3, wherein the software access API is compatible with the central controller and is invoked to transmit the audio signal to central controller and to read the control command from the central controller.

5. The wireless voice transparent transmission apparatus of claim 1, wherein the RF module includes one of a Wi-Fi module, a Bluetooth module, a ZigBee module, and a Wireless 433 module.

6. The wireless voice transparent transmission apparatus of claim 1, wherein the input unit includes at least one microphone.

7. A method for wireless voice transparent transmission, comprising:
collecting, by an input unit of a wireless voice transparent transmission apparatus, a voice command;
acquiring, by a control unit of the wireless voice transparent transmission apparatus, an audio signal corresponding to the voice command collected by the input unit in real time;
establishing, by a software access application programming interface (API) executed on the wireless voice transparent transmission apparatus, a wireless network connection between a radio frequency (RF) module and at least one wireless terminal; and
transmitting the audio signal acquired by the control unit from the RF module to the at least one wireless terminal.

8. The method of claim 7, wherein acquiring the audio signal comprises:
detecting a voice input in real time; and
in response to detecting the voice input, triggering and performing an audio signal acquisition process until detecting an end of the voice input to obtain the audio signal.

9. The method of claim 7, wherein: the at least one wireless terminal includes a central controller of a voice transmission system.

10. The method of claim 7, further comprising.
receiving, by the wireless voice transparent transmission apparatus, a control command from the central controller; and
informing the control unit to execute the control command.

11. The method of claim 10, wherein the software access API is compatible with the central controller and is invoked to transmit the audio signal to the central controller and to read the control command from the central controller.

12. The method of claim 11, further comprising:
configuring a voice transmission API in an existing voice controller device, wherein the voice transmission API is compatible with the software access API executed on the wireless voice transparent transmission apparatus and the existing voice controller device functions as the central controller; and
invoking the voice transmission API to process the audio signal and generate the control command.

13. The method of claim 9, further comprising:
analyzing, by the central controller, the audio signal sent by the wireless voice transparent transmission apparatus to obtain the voice command, the voice command being directed to request a second wireless terminal to execute a corresponding operation; and
sending, by the central controller, a control signal to the second wireless terminal corresponding to the voice command, the control signal being configured to control the second wireless terminal to execute the corresponding operation.

14. The method of claim 9, further comprising:
when multiple audio signals are transmitted in a same time period, operating, by the central controller, at a monopoly mode in which only one of the multiple audio signal is processed.

15. The method of claim 14, further comprising:
selecting the only one of the multiple audio signal to be processed by the central controller based on at least one of signal collection times of the multiple audio signals or priority levels corresponding to the multiple audio signals.

16. The method of claim 9, further comprising:
when multiple audio signals are transmitted in a same time period, operating, by the central controller, at a parallel mode in which the multiple audio signals are processed respectively, including:
determining, by the central controller, whether a current audio signal contains a voice command indicating a same control operation type as a previous voice command directed to a same wireless terminal;
if the current audio signal contains a voice command indicating the same control operation type as the previous voice command directed to the same wireless terminal, discarding the current audio signal; and
if the current audio signal does not contain a voice command indicating the same control operation type as the previous voice command directed to the same wireless terminal, sending a control signal corresponding to the voice command to a corresponding wireless terminal to execute an operation indicated by the voice command.

17. A voice control system, comprising:
a plurality of wireless terminals, including at least a first wireless terminal and a second wireless terminal; and
a central controller wirelessly connected to the plurality of wireless terminals;
wherein:
the first wireless terminal is a voice transparent transmission apparatus configured to:
acquire an audio signal corresponding to a voice command collected in real time;
invoke a software access application programming interface (API) to establish a wireless connection between the voice transparent transmission apparatus and the central controller; and
transmit the audio signal to the central controller; and
the central controller is configured to:
analyze the audio signal to obtain the voice command, the voice command being directed to request the second wireless terminal to execute a corresponding operation; and
send a control signal to the second wireless terminal corresponding to the voice command, the control signal being configured to control the second wireless terminal to execute the corresponding operation.

18. The voice control system of claim 17, wherein the central controller is further configured to:
invoke a voice transmission API to process the audio signal and generate the control signal, wherein the voice transmission API is compatible with the software access API executed on the wireless voice transparent transmission apparatus.

19. The voice control system of claim 17, wherein the central controller is further configured to:
when multiple audio signals are transmitted in a same time period, operate at a monopoly mode in which only one of the multiple audio signal is processed; and
select the only one of the multiple audio signal to be processed based on at least one of signal collection times of the multiple audio signals or priority levels corresponding to the multiple audio signals.

20. The voice control system of claim 17, wherein the central controller is further configured to:
when multiple audio signals are transmitted in a same time period, operate at a parallel mode in which the multiple audio signals are processed respectively, including:
determining whether a current audio signal contains a voice command indicating a same control operation type as a previous voice command directed to a same wireless terminal;
if the current audio signal contains a voice command indicating the same control operation type as the previous voice command directed to the same wireless terminal, discarding the current audio signal; and
if the current audio signal does not contain a voice command indicating the same control operation type as the previous voice command directed to the same wireless terminal, sending a control signal corresponding to the voice command to a corresponding wireless terminal to execute an operation indicated by the voice command.
